(19) United States
(12) Patent Application Publication
(10) Pub. No.: US 2017/0285889 A1
(43) Pub. Date: Oct. 5, 2017

(54) SCENARIO BASED PINNING IN A COLLABORATION ENVIRONMENT

(71) Applicant: Microsoft Technology Licensing, LLC, Redmond, WA (US)

(72) Inventors: John L. DeMaris, Seattle, WA (US); Angela Allison, Redmond, WA (US)

(21) Appl. No.: 15/194,426

(22) Filed: Jun. 27, 2016

Related U.S. Application Data
(60) Provisional application No. 62/318,751, filed on Apr. 5, 2016.

(51) Int. Cl. G06F 3/0482; G06F 3/0484; G06F 17/30

(52) U.S. Cl. CPC G06F 3/0482; G06F 17/30896; G06F 3/0484; G06F 3/04847; G06F 3/04845

(57) ABSTRACT

Aspects of the present disclosure relate to systems and methods for pinning items that span across multiple containers in a collaboration environment. In one aspect, a set of pinned items may be provided based on a container. For example, a first container may comprise a folder having a first metadata driven view that includes a first set of pinnable items. In another example, a second container may comprise the folder having a second metadata driven view that includes a second set of pinnable items. Pinnable items from the first set of pinnable items may be pinned as a tile in a top position within the first metadata driven view. Pinnable items from the second set of pinnable items may be pinned as a tile in a top position within the second metadata driven view.

### CROSS-REFERENCE TO RELATED APPLICATION(S)

This application is a Non-Provisional of, and claims priority to U.S. Provisional Patent Application No. 62/318,751, filed Apr. 5, 2016, entitled “SCENARIO BASED PINNING IN A COLLABORATION ENVIRONMENT,” which application is incorporated herein by reference in its entirety.

### BACKGROUND

Applications may provide for the pinning of items in a prominent location in the application space. For example, the application may provide an action that allows a user of the application to place an item being pinned in a prominent location (e.g., at the top of a list of items). Existing pinning techniques provide for pinning of items that are part of a large range of items from various categories and/or locations. For example, a user may pin an item (e.g., a file) from a list of most recently used files by the user in the top position of the list of mostly recently used files. In this regard, the pinned item/file is still part of the list of most recently used files, but located in a top position. In turn, existing pinning techniques provide for pinning items within a single container for the benefit of a user of the items.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In summary, the disclosure generally relates to systems and methods for pinning items that span across multiple containers in a collaboration environment. In one aspect, a set of pinned items may be provided based on a container. For example, a first container comprising a folder having a first metadata driven view may be rendered in a user interface of a file sharing tool. The first container may include a first set of pinnable items. In response to receiving a selection of a first pin associated with a first pinnable item of the first set of pinnable items, the first pinnable item may be pinned as a tile in a top position within the first metadata driven view. In response to receiving a selection of a second pin associated with a second pinnable item of the first set of pinnable items, the second pinnable item may be pinned adjacent to the first pinnable item as a tile in the top position within the first metadata driven view.

In another aspect, rendering of a shared library of content within a file sharing tool may be initiated. The shared library of content may include at least one or more folders. In response to receiving a selection of a first of the one or more folders, rendering of a first set of pinnable items within the first selected folder may be initiated. In response to receiving a selection of a second of the one or more folders, rendering of a second set of pinnable items within the second selected folder may be initiated. The first set of pinnable items may include at least one pinnable item that is different from the second set of pinnable items.

In further aspects, a file sharing tool may render a first metadata driven view in a user interface to the file sharing tool. The first metadata driven view includes a first set of pinnable items that match a first set of metadata values. In response to receiving a selection of a pin associated with a pinnable item of the first set of pinnable items, the pinnable item associated with the selected pin may be pinned as a tile in a top position within the first metadata driven view. The file sharing tool may render a second metadata drive view in the user interface to the file sharing tool. The second metadata driven view includes a second set of pinnable items that match a second set of metadata values. In response to receiving a selection of a pin associated with a pinnable item of the second set of pinnable items, the pinnable item associated with the selected pin may be pinned as a tile in a top position within the second metadata driven view.

### DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an exemplary container for pinning a set of items, according to an example aspect.

FIG. 2 illustrates an exemplary container for pinning a set of items, according to an example aspect.

FIG. 3 illustrates an exemplary container for pinning a set of items, according to an example aspect.

FIG. 4 illustrates an exemplary container for pinning a set of items, according to an example aspect.

FIG. 5 illustrates an exemplary container for pinning a set of items, according to an example aspect.

FIG. 6 illustrates an exemplary container for pinning a set of items, according to an example aspect.

FIG. 7 illustrates an exemplary method for providing a set of pinned items based on a container, according to an example aspect.

FIG. 8 illustrates a computing system suitable for implementing the enhanced pinning technology disclosed herein, including any of the environments, architectures, elements, processes, user interfaces, and operational scenarios and sequences illustrated in the Figures and discussed below in the Technical Disclosure.

### DETAILED DESCRIPTION

Aspects of the disclosure are generally directed to systems and methods for pinning items that span across multiple containers in a collaboration environment. For example, rendering of a shared library of content within a file sharing tool may be initiated. The shared library of content may include at least one or more folders. In response to receiving a selection of a first of the one or more folders, rendering of a first set of pinnable items within the first selected folder may be initiated. In response to receiving a selection of a second of the one or more folders, rendering of a second set of pinnable items within the second selected folder may be initiated. In one example, the first set of pinnable items includes at least one pinnable item that is different from the second set of pinnable items.

In another aspect, a first metadata driven view may be rendered in a user interface to a file sharing tool. The first metadata driven view may include a first set of pinnable items that match a first set of metadata values. In response to receiving a selection of a pin associated with a pinnable item of the first set of pinnable items, the pinnable item associated with the selected pin may be pinned as a tile in a top position within the first metadata driven view. A second metadata drive view may be rendered in the user interface to the file sharing tool. The second metadata driven view may include a second set of pinnable items that match a second set of metadata values. In response to receiving a selection of a pin associated with a pinnable item of the second set of pinnable items, the pinnable item associated with the selected pin may be pinned as a tile in a top position within the second metadata driven view.

Accordingly, aspects described herein include tools and/or techniques that make pinning items in a collaboration environment intuitive, user-friendly, and efficient. In this regard, relevant items (e.g., files) may be pinned to the top of the relevant space (e.g., within a view) so that co-authors/collaborators of the relevant space can quickly make progress on the items deemed most important. In another aspect, relevant items may be pinned to the top of a particular space so that visitors to the particular space immediately view the most important items first. In this regard, visitors to the particular space don't have to wade through a distracting number of items and/or information. As such, a technical effect that may be appreciated is that the tools and/or techniques disclosed herein provide a compelling visual and functional experience for users to pin and/or view items in a collaboration environment intuitively and efficiently through interaction with a user interface.

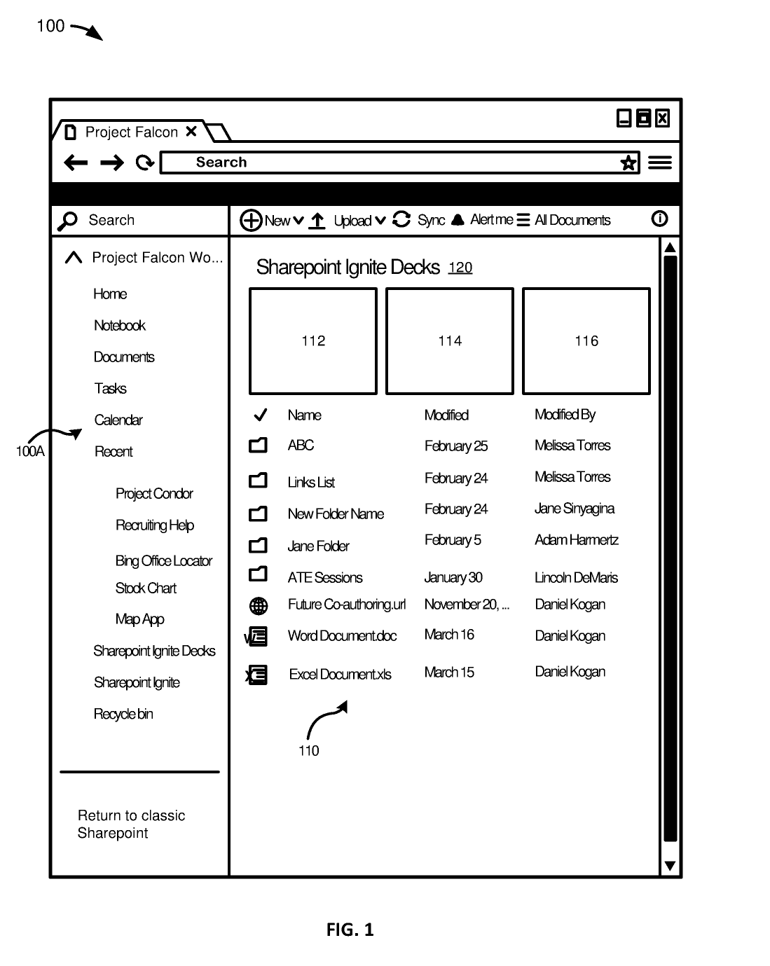

Referring now to the drawings, in which like numerals represent like elements through the several figures, aspects of the present disclosure and the exemplary operating environment will be described. With reference to FIG. 1, a container 100A of a file sharing tool 100 for pinning a set of items 110 is illustrated. In some examples, the file sharing tool 100 may include any file sharing tool suitable for processing and/or managing files associated with an application. In one case, the file sharing tool 100 may facilitate collaboration and/or co-authoring of files. For example, the file sharing tool 100 may include a service such as OneDrive, SharePoint, Dropbox, and the like. In another example, the file sharing tool 100 may include any service suitable for processing and/or managing any type of content located in a collaboration environment such as web pages, links to external resources, rich media (e.g., images, pictures, and video), tasks, and the like. In this regard, the set of items 110 that may be pinned may include any content located in a collaboration environment as described herein such as files, web pages, links to external resources, rich media, tasks, and the like.

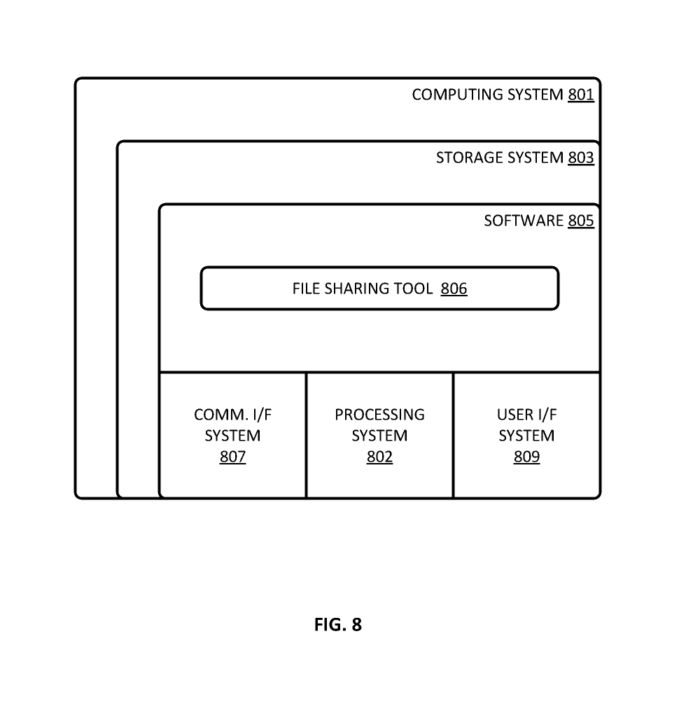

In aspects, the file sharing tool 100 and/or container 100A of a file sharing tool 100 for pinning a set of items 110 may be implemented on a client computing device (e.g., such as the computing device illustrated in FIG. 8). In a basic configuration, the client computing device is a handheld computer having both input elements and output elements. The client computing device may be any suitable computing device for implementing the file sharing tool 100 and/or container 100A of a file sharing tool 100 for pinning a set of items 110. For example, the client computing device may be at least one of: a mobile telephone; a smart phone; a tablet; a phablet; a smart watch; a wearable computer; a personal computer; a desktop computer; a laptop computer; a gaming device/computer (e.g., Xbox); a television; and etc. This list is exemplary only and should not be considered as limiting. Any suitable client computing device for implementing the file sharing tool 100 and/or container 100A of a file sharing tool 100 for pinning a set of items 110 may be utilized.

In aspects, the file sharing tool 100 and/or container 100A of a file sharing tool 100 for pinning a set of items 110 may be implemented on a server computing device (e.g., such as the computing device illustrated in FIG. 8). The server computing device may provide data to and from the client computing device through a network. In aspects, the file sharing tool 100 and/or container 100A of a file sharing tool 100 may be implemented on more than one server computing device, such as a plurality of server computing devices. As discussed above, the server computing device may provide data to and from the client computing device through the network. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums. In this regard, a container including a set of pinnable items may be rendered and/or displayed in a user interface of the client computing device.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

In aspects, the container 100A includes a shared library of content. The shared library of content illustrated in FIG. 1 is a SharePoint Ignite Decks library. The shared library of content includes the set of items 110. The set of items 110, as illustrated in FIG. 1, includes one or more files, rich media, and/or one or more folders. In one example, the set of items 110 may include pinnable items. Any number of items of the set of items 110 may include pinnable items. In one example, pinnable items are items that may include a pin and may be pinned within the container 100A and/or the file sharing tool 100. In one example, in response to receiving a selection of a pin associated with one of the set of items 110, the item associated with the selected pin may be pinned as a tile to a top position 120 within the container 100A. In one example, in response to receiving a selection of one of the one or more folders, a set of pinnable items may be rendered and/or displayed within the selected folder (not illustrated). In another example, the set of pinnable items rendered and/or displayed within the selected folder may be specific to the selected folder and/or have a specific purpose relative to the selected folder. In this regard, each folder within the container 100A may include its own unique set of pinnable items. As such, the set of pinnable items may change from folder to folder within the container 100A. In another example, in response to receiving a selection of a pin associated with one of the pinnable items of the set of pinnable items included in the selected folder, the pinnable item associated with the selected pin may be pinned as a tile to a top position within the selected folder (not illustrated).

As illustrated in FIG. 1, the top position 120 within the container 100A may include one or more pinned items displayed as tiles. For example, the top position 120 within the container 100A includes a first pinned item 112 displayed as a first tile, a second pinned item 114 displayed as a second tile, and a third pinned item 116 displayed as a third tile. In this regard, users, co-authors, and/or visitors associated with the container 100A may quickly and easily view items deemed important to the container 100A (e.g., the SharePoint Ignite Decks Library).

It is appreciated that while FIG. 1 illustrates a container 100A including a shared library of content (e.g., the SharePoint Ignite Decks Library), the container 100A may include one or more folders, one or more metadata driven views, and/or one or more folders including one or more metadata driven views. In one example, a metadata driven view is a view that includes pinnable items that match a set of metadata values. For example, the pinnable items within a metadata driven view may include those items that are classified based on metadata values. In one case, the set of metadata values may include any metadata that describes and/or classifies an item such as a topic, audience, speakers, a time associated with creation of the item, a genre, a type of item, a project, and the like. It is further appreciated that while FIG. 1 illustrates the set of items 110, the set of items 110 may be unique to the container 100A in which the set of items 110 is included. For example, the set of items 110 may include files, web pages, and links to external resources, rich media (e.g., images, pictures, and video), tasks, and the like, having a specific purpose relative to the container 100A.

In one aspect, a user interface component may be configured to display a container and/or a metadata driven view including one or more pinnable items. In one aspect, the user interface component may render a container within a file sharing tool. In one example, the user interface component may be a touchable user interface that is capable of receiving input via contact with a screen of the client computing device, thereby functioning as both an input device and an output device. For example, content may be displayed, or output, on the screen of the client computing device and input may be received by contacting the screen using a stylus or by direct physical contact of a user, e.g., touching the screen. Contact may include, for instance, tapping the screen, using gestures such as swiping or pinching the screen, sketching on the screen, etc.

In another example, the user interface component may be a non-touch user interface. In one case, a tablet device, for example, may be utilized as a non-touch device when it is docked at a docking station (e.g., the tablet device may include a non-touch user interface). In another case, a desktop computer may include a non-touch user interface. In this example, the non-touchable user interface may be capable of receiving input via contact with a screen of the client computing device, thereby functioning as both an input device and an output device. For example, content may be displayed, or output, on the screen of the client computing device and input may be received by contacting the screen using a cursor, for example. In this regard, contact may include, for example, placing a cursor on the non-touchable user interface using a device such as a mouse.

In some aspects, the file sharing tool, container, items, folders, and/or metadata driven views may be part of and/or located at a client computing device. In other aspects, the file sharing tool, container, items, folders, and/or metadata driven views may be located at a server computing device. In yet other aspects, portions of the file sharing tool, container, items, folders, and/or metadata driven views may be located at a client computing device, and portions of the file sharing tool, container, items, folders, and/or metadata driven views may be located at a server computing device.

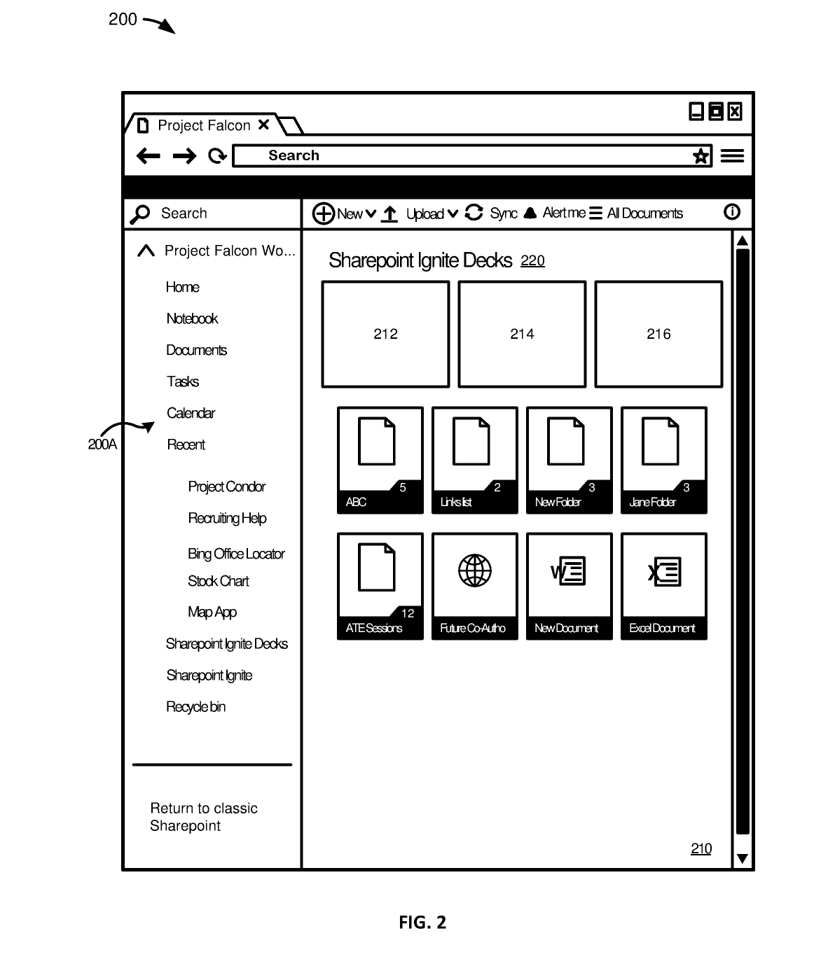

Referring now to FIG. 2, an example container 200A of a file sharing tool 200 for pinning a set of items 210 is illustrated. In some examples, the file sharing tool 200 may include any file sharing tool suitable for processing and/or managing files associated with an application. In one case, the file sharing tool 200 may facilitate collaboration and/or co-authoring of files. For example, the file sharing tool 200 may include a service such as OneDrive, SharePoint, Dropbox, and the like. In another example, the file sharing tool 200 may include any service suitable for processing and/or managing any type of content located in a collaboration environment such as web pages, links to external resources, rich media (e.g., images, pictures, and video), tasks, and the like. In this regard, the set of items 210 that may be pinned may include any content located in a collaboration environment as described herein such as files, web pages, links to external resources, rich media, tasks, and the like.

In aspects, the file sharing tool 200 and/or container 200A of a file sharing tool 200 for pinning a set of items 210 may be implemented on a client computing device (e.g., such as the computing device illustrated in FIG. 8). In aspects, the file sharing tool 200 and/or container 200A of a file sharing tool 200 for pinning a set of items 210 may be implemented on a server computing device (e.g., such as the computing device illustrated in FIG. 8).

In aspects, the container 200A includes a shared library of content. The shared library of content illustrated in FIG. 2 is a SharePoint Ignite Decks library. The shared library of content includes the set of items 210. The set of items 210, as illustrated in FIG. 2, include one or more files, rich media, and/or one or more folders. In this example, the set of items 210 are in the form of thumbnails. In one case, thumbnails represent a scaled down version of the items 210 such as software applications, files, and/or images such as documents, spreadsheets, presentation slides, and other objects. In one example, the set of items 210 may include pinnable items. Any number of items of the set of items 210 may include pinnable items. In one example, pinnable items are items that may include a pin and may be pinned within the container 200A and/or the file sharing tool 200. In one example, in response to receiving a selection of a pin associated with one of the set of items 210, the item associated with the selected pin may be pinned as a tile to a top position 220 within the container 200A. In one example, in response to receiving a selection of one of the one or more folders, a set of pinnable items may be rendered and/or displayed within the selected folder (not illustrated). In another example, the set of pinnable items rendered and/or displayed within the selected folder may be specific to the selected folder and/or have a specific purpose relative to the selected folder. In this regard, each folder within the container 200A may include its own unique set of pinnable items. As such, the set of pinnable items may change from folder to folder within the container 200A. In another example, in response to receiving a selection of a pin associated with one of the pinnable items of the set of pinnable items included in the selected folder, the pinnable item associated with the selected pin may be pinned as a tile to a top position within the selected folder (not illustrated).

As illustrated in FIG. 2, the top position 220 within the container 200A may include one or more pinned items displayed as tiles. For example, the top position 220 within the container 200A includes a first pinned item 212 displayed as a first tile, a second pinned item 214 displayed as a second tile, and a third pinned item 216 displayed as a third tile. As illustrated in FIG. 2, the pinned items displayed as tiles (e.g., 212, 214, 216) are distinguished from the set of items 210 by their size, position, and aspect ratio. In this regard, users, co-authors, and/or visitors associated with the container 200A may quickly and easily view items deemed important to the container 200A (e.g., the SharePoint Ignite Decks Library).

It is appreciated that while FIG. 2 illustrates a container 200A including a shared library of content (e.g., the SharePoint Ignite Decks Library), the container 200A may include one or more folders, one or more metadata driven views, and/or one or more folders including one or more metadata driven views. In one example, a metadata driven view is a view that includes pinnable items that match a set of metadata values. For example, the pinnable items within a metadata driven view may include those items that are classified based on metadata values. In one case, the set of metadata values may include any metadata that describes and/or classifies an item such as a topic, audience, speakers, a time associated with creation of the item, a genre, a type of item, a project, and the like. It is further appreciated that while FIG. 2 illustrates the set of items 210, the set of items 210 may be unique to the container 200A in which the set of items 210 is included. For example, the set of items 210 may include files, web pages, and links to external resources, rich media (e.g., images, pictures, and video), tasks, and the like, having a specific purpose relative to the container 200A.

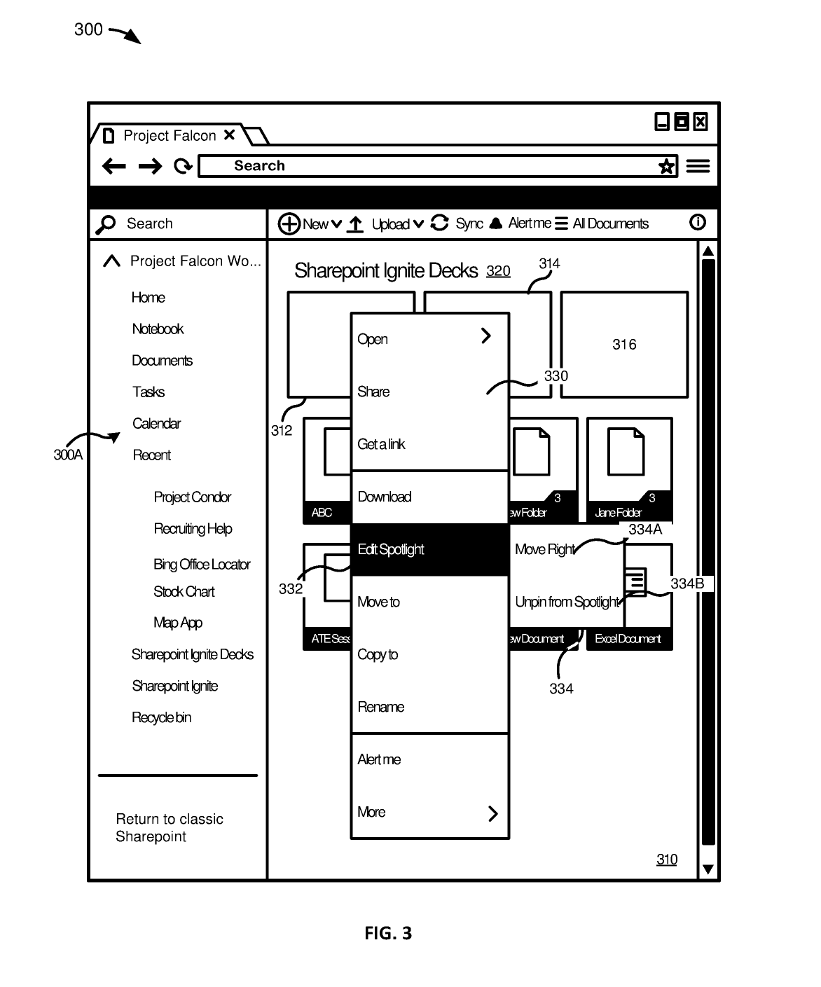

Referring now to FIG. 3, an example container 300A of a file sharing tool 300 for pinning a set of items 310 is illustrated. The container 300A includes a top position 320 for displaying one or more pinned items as tiles. For example, the top position 320 within the container 300A includes a first pinned item 312 displayed as a first tile, a second pinned item 314 displayed as a second tile, and a third pinned item 316 displayed as a third tile. In one example, the pinned items displayed as tiles (e.g., 312, 314, 316) may be relocated within the top position 320. For example, the container 300A may include an action pane 330. The action pane 330 may include at least an edit option 332 associated with the pinned items displayed as tiles (e.g., 312, 314, 316). In one example, in response to receiving a selection of the edit option 332, an edit pane 334 may be displayed. The edit pane 334 may include at least a relocation option 334A for relocating a pinned item and an unpin option 334B for unpinning a pinned item. In one example, the relocation option 334A for relocating the pinned item may include moving the pinned item to the right. In one example, the first pinned item 312 may be moved to the right using the relocation option 334A. In another example, the second pinned item 314 may be moved to the right using the relocation option 334A. In yet another example, the second pinned item 314 may be moved to the left using the relocation option 334A. In another example, the unpin option 334B for unpinning a pinned item may include removing a pinned item (e.g., 312, 314, 316) from the top position 320 of the container 300A. In this regard, pinned items may be easily and efficiently moved around and/or changed via interaction with a user interface.

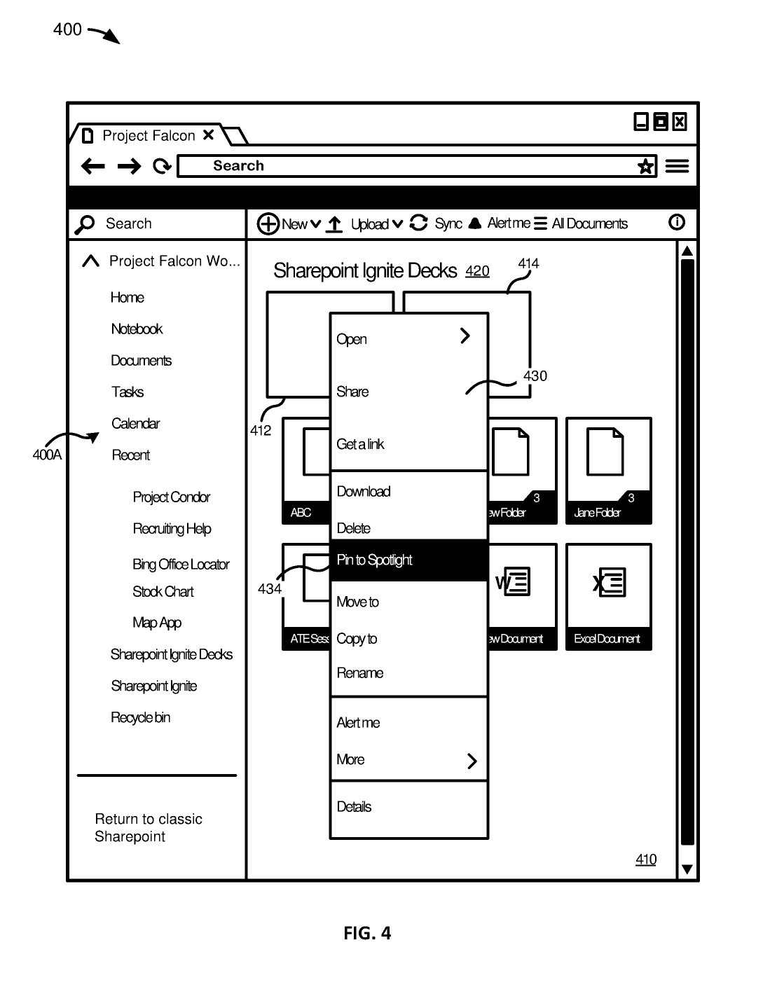

FIG. 4 illustrates an example container 400A of a file sharing tool 400 for pinning a set of items 410, according to an example aspect. The container 400A includes a top position 420 for displaying one or more pinned items as tiles. For example, the top position 420 within the container 400A includes a first pinned item 412 displayed as a first tile and a second pinned item 414 displayed as a second tile. In one example, the pinned items displayed as tiles (e.g., 412, 414) may be pinned within the top position 420 in response to receiving a selection of a pinning option 432. For example, the container 400A may include an action pane 430. The action pane 430 may include at least the pinning option 432 for pinning one or more items as a tile in a top position (e.g., 420) within the container 400A. In another example, each item of the set of items 410 may include a pin (e.g., a pinning icon) for pinning the item as a tile in a top position (e.g., 420) within the container 400A. For example, in response to receiving a selection of the pin associated with an item of the set of items 410, the item may be pinned as a tile in the top position 420 of the container 400A.

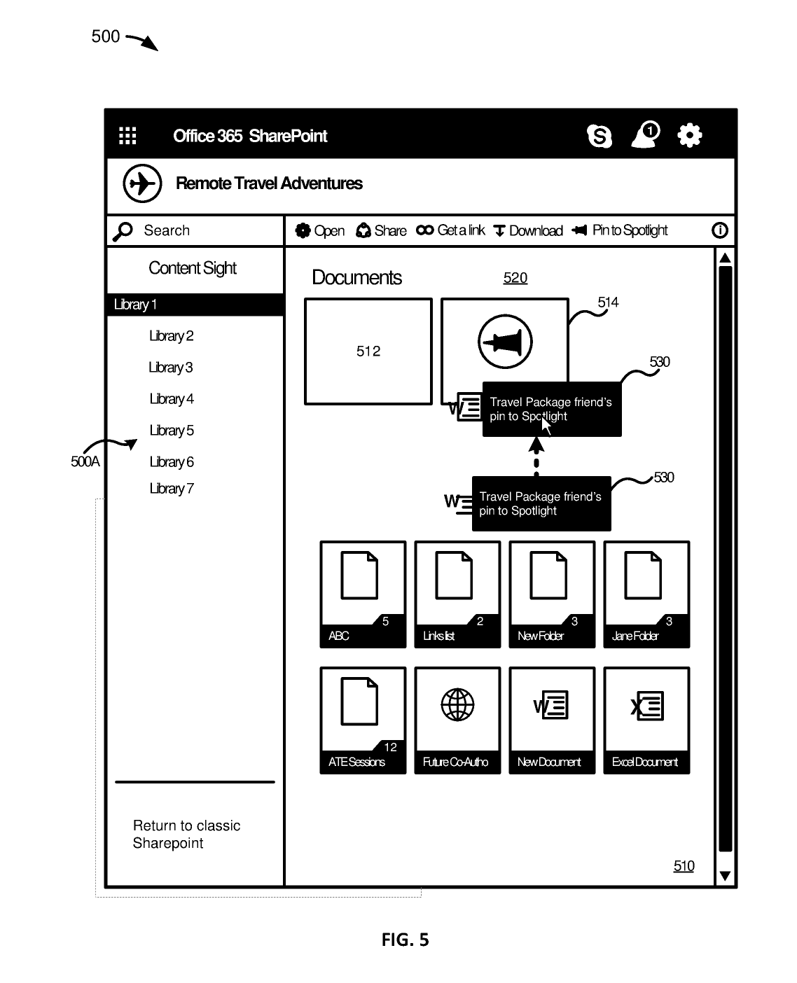

FIG. 5 illustrates an example container 500A of a file sharing tool 500 for pinning a set of items 510, according to an example aspect. The container 500A includes a top position 520 for displaying one or more pinned items as tiles. For example, the top position 520 within the container 500A includes a first pinned item 512 displayed as a first tile. In one example, the pinned items displayed as tiles (e.g., 512) may be pinned within the top position 520 in response to receiving a drag and drop action 530. For example, a user may drag an item from the set of items 510 to the top position 520 within the container 500A and drop the item from the set of items 510 into a tile 514. In this regard, in response to receiving a drag and drop action 530 of an item, the item may be pinned as a tile (e.g., 514) in the top position 520 of the container 500A.

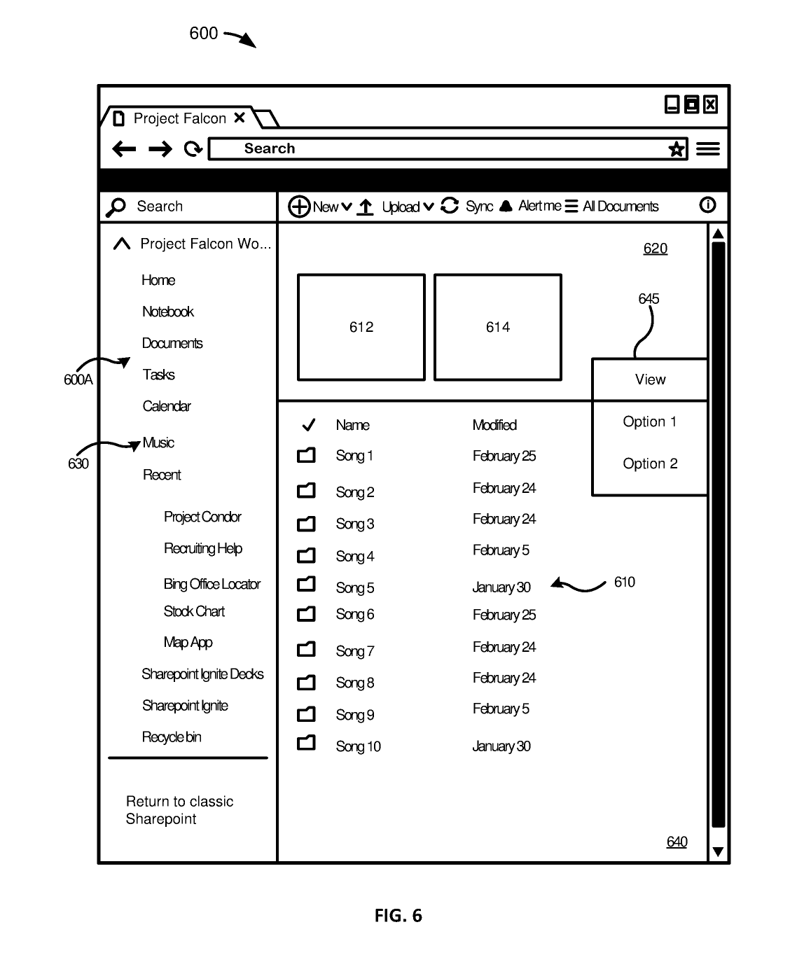

Referring now to FIG. 6, an example container 600A of a file sharing tool 600 for pinning a set of items 610 is illustrated. In some examples, the file sharing tool 600 may include any file sharing tool suitable for processing and/or managing files associated with an application. In one case, the file sharing tool 600 may facilitate collaboration and/or co-authoring of files. For example, the file sharing tool 600 may include a service such as OneDrive, SharePoint, Dropbox, and the like. In another example, the file sharing tool 600 may include any service suitable for processing and/or managing any type of content located in a collaboration environment such as web pages, links to external resources, rich media (e.g., images, pictures, and video), tasks, and the like. In this regard, the set of items 610 that may be pinned may include any content located in a collaboration environment as described herein such as files, web pages, links to external resources, rich media, tasks, and the like.

In aspects, the file sharing tool 600 and/or container 600A of a file sharing tool 600 for pinning a set of items 610 may be implemented on a client computing device (e.g., such as the computing device illustrated in FIG. 8). In aspects, the file sharing tool 600 and/or container 600A of a file sharing tool 600 for pinning a set of items 610 may be implemented on a server computing device (e.g., such as the computing device illustrated in FIG. 8).

In aspects, the container 600A includes a folder 630 having a metadata driven view 640. The folder 630 illustrated in FIG. 6 is a music folder. The music folder 630 includes the set of items 610. The set of items 610, as illustrated in FIG. 6, include ten songs, song 1-song 10. In one example, the set of items 610 may include pinnable items. Any number of items of the set of items 610 may include pinnable items. In one example, pinnable items are items that may include a pin and may be pinned within the container 600A and/or the file sharing tool 600. In one example, in response to receiving a selection of a pin associated with one of the set of items 610, the item associated with the selected pin may be pinned as a tile to a top position 620 within the container 600A. In another example, the set of pinnable items 610 may be specific to the selected folder 630 and/or have a specific purpose relative to the selected folder 630. For example, the selected folder 630 is a music folder. As such, the set of pinnable items 610 includes a plurality of songs. In this regard, each folder within the container 600A may include its own unique set of pinnable items. As such, the set of pinnable items may change from folder to folder within the container 600A.

In another example, the set of items 610 may be specific and/or relative to the metadata driven view 640. For example, the set of items 610 may match a set of metadata values. For example, the pinnable items 610 within the metadata driven view 640 may include those items that are classified based on metadata values. In one case, the set of metadata values may include any metadata that describes and/or classifies an item such as a topic, audience, speakers, a time associated with creation of the item, a genre, a type of item, a project, and the like. In one example, items may be queried based on metadata and/or metadata values. For example, a user may query the music folder 630 using a query and/or view tool 645. In one case, the user may query the music folder 630 based on music genres (e.g., hip hop songs). In this regard, the pinnable items 610 may include a unique set of songs associated with the metadata driven view 640 (e.g., hip hop songs) and/or the music folder 630. In this example, the ten songs, songs 1-10 are hip hop songs unique to the metadata driven view 640. In another example, a second metadata driven view (not illustrated) may be rendered and/or displayed within the folder 630 based on a set of metadata values. For example, the second metadata driven view may include songs of the rock genre. In this regard, pinnable items (e.g., rock songs) may be unique to the second metadata driven view and displayed within the music folder 630. In this example, the items pinned to a top portion within the second metadata driven view may be different than the items (e.g., 612, 614) pinned to the top portion 620 within the metadata driven view 640. In another example, in response to receiving a selection of a pin associated with one of the pinnable items (e.g., songs 1-10) of the set of pinnable items 610 included in the selected folder 630 and/or the metadata driven view 640, the pinnable item associated with the selected pin may be pinned as a tile (e.g., 612, 614) to the top position 620 within the metadata driven view 640.

As illustrated in FIG. 6, the top position 620 within the container 600A may include one or more pinned items displayed as tiles. For example, the top position 620 within the container 600A includes a first pinned item 612 displayed as a first tile and a second pinned item 614 displayed as a second tile. As illustrated in FIG. 6, the pinned items displayed as tiles (e.g., 612, 614) are distinguished from the set of items 610 by their size, position, and aspect ratio. In this regard, users, co-authors, and/or visitors associated with the container 600A may quickly and easily view items deemed important to the container 600A (e.g., the music folder 630 and/or the metadata driven view 640).

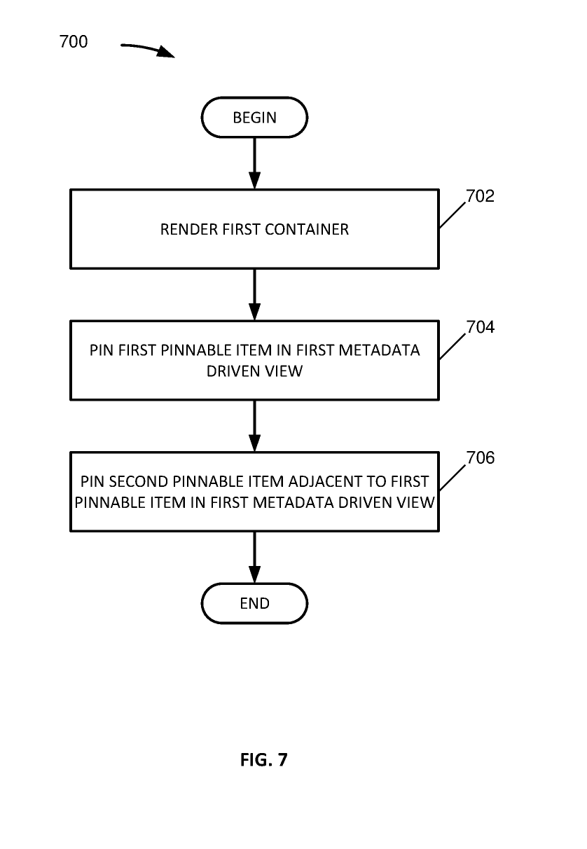

Referring now to FIG. 7, an exemplary method 700 for providing a set of pinned items based on a container, according to an example aspect is shown. Method 700 may be implemented on a computing device or a similar electronic device capable of executing instructions through at least one processor. Method 700 may begin at operation 702, where a first container comprising a folder having a first metadata driven view is rendered in a user interface of a file sharing tool. In one example, the first container includes a first set of pinnable items. In one example, the first container may include a shared library of content. In some examples, the first set of pinnable items may include at least one of files, web pages, links to external resources, rich media, and tasks. In some examples, the first set of pinnable items match a set of metadata values associated with the first metadata driven view

In response to receiving a selection of a first pin associated with a first pinnable item of the first set of pinnable items, flow proceeds to operation 704 where the first pinnable item is pinned as a tile in a top position within the first metadata driven view. In one example, the first pinnable item pinned as a tile in a top position within the first metadata driven view is distinguished from the first set of pinnable items by size, position and aspect ratio. In some examples, the first set of pinnable items within the metadata driven view may include those items that are classified based on metadata values. In one case, the set of metadata values may include any metadata that describes and/or classifies an item such as a topic, audience, speakers, a time associated with creation of the item, a genre, a type of item, a project, and the like.

In response to receiving a selection of a second pin associated with a second pinnable item of the first set of pinnable items, flow proceeds to operation 706 where the second pinnable item is pinned adjacent to the first pinnable item as a tile in the top position within the first metadata driven view. In one example, the second pinnable item pinned as a tile in a top position within the first metadata driven view is distinguished from the first set of pinnable items by size, position and aspect ratio. In some examples, the second pinnable item pinned adjacent to the first pinnable item as a tile in the top position within the first metadata driven view may be relocated within the top position of the first metadata driven view. For example, in response to receiving a selection of a relocation option, the second pinnable item pinned adjacent to the first pinnable item may be relocated (e.g., moved) to a different location within the top position of the first metadata driven view.

FIG. 8 illustrates computing system 801 that is representative of any system or collection of systems in which the various applications, services, scenarios, and processes disclosed herein may be implemented. Examples of computing system 801 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803.

Software 805 includes file sharing tool 806, which is representative of the file sharing tool discussed with respect to FIGS. 1-7 including the containers, items, folders and metadata driven views described herein. When executed by processing system 802 to enhance pinning items, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device, but may also be distributed across multiple processing devices or sub-systems that cooperate in executing program instructions. Examples of processing system 802 include general purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device, but may also be implemented across multiple storage devices or sub-systems co-located or distributed relative to each other. Storage system 803 may comprise additional elements, such as a controller, capable of communicating with processing system 802 or possibly other systems.

Software 805 may be implemented in program instructions and among other functions may, when executed by processing system 802, direct processing system 802 to operate as described with respect to the various operational scenarios, sequences, and processes illustrated herein. For example, software 805 may include program instructions for implementing enhanced pinning of items.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtual machine software, or other application software, in addition to or that include application 806. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to facilitate enhanced pinning of items. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here.

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Among other examples, the present disclosure presents methods for providing a set of pinned items based on a container, the method comprising: rendering a first container comprising a folder having a first metadata driven view in a user interface of a file sharing tool, wherein the first container includes a first set of pinnable items; in response to receiving a selection of a first pin associated with a first pinnable item of the first set of pinnable items, pinning the first pinnable item as a tile in a top position within the first metadata driven view; and in response to receiving a selection of a second pin associated with a second pinnable item of the first set of pinnable items, pinning the second pinnable item adjacent to the first pinnable item as a tile in the top position within the first metadata driven view. In further examples, rendering a second container comprising the folder having a second metadata driven view in the user interface of the file sharing tool, wherein the second container includes a second set of pinnable items. In further examples, the first set of pinnable items includes at least one of files, web pages, links to external resources, rich media, and tasks. In further examples, the first container includes a shared library of content. In further examples, the first set of pinnable items match a set of metadata values associated with the first metadata driven view. In further examples, the second set of pinnable items match a set of metadata values associated with the second metadata driven view. In further examples, the first container includes an action pane including at least an edit option associated with the first pinnable item pinned as a tile and the second pinnable item pinned as a tile. In further examples, in response to receiving a selection of the edit option, displaying an edit pane including at least a relocation option and an unpin option. In further examples, in response to receiving a selection of the relocation option, relocating at least one of the first pinnable item pinned as a tile and the second pinnable item pinned as a tile within the top position of the first metadata driven view. In further examples, in response to receiving a selection of the unpin option, removing at least one of the first pinnable item pinned as a tile and the second pinnable item pinned as a tile from the top position of the first metadata driven view.

Further examples disclosed herein provide an exemplary system comprising: one or more computer readable storage media; and program instructions stored on the one or more computer readable storage media that, when executed by at least one processor, cause the at least one processor to at least: initiate rendering of a shared library of content within a file sharing tool, wherein the shared library of content includes at least one or more folders; in response to receiving a selection of a first of the one or more folders, initiate rendering of a first set of pinnable items within the first selected folder; and in response to receiving a selection of a second of the one or more folders, initiate rendering of a second set of pinnable items within the second selected folder, wherein the first set of pinnable items includes at least one pinnable item that is different from the second set of pinnable items. In further examples, each folder of the one or more folders includes a unique set of pinnable items. In further examples, in response to receiving a selection of a pin associated with a first pinnable item of the first set of pinnable items, pinning the first pinnable item as a tile in a top position within the first selected folder. In further examples, in response to receiving a selection of a pin associated with a first pinnable item of the second set of pinnable items, pinning the first pinnable item as a tile in a top position within the second selected folder. In further examples, in response to receiving a selection of a pin associated with a second pinnable item of the first set of pinnable items, pinning the second pinnable item adjacent to the first pinnable item as a tile in a top position within the first selected folder. In further examples, in response to receiving a selection of a pin associated with a second pinnable item of the second set of pinnable items, pinning the second pinnable item adjacent to the first pinnable item as a tile in a top position within the second selected folder.

Additional aspects disclosed herein provide exemplary computing apparatus comprising: one or more computer readable storage media; a processing system operatively coupled with the one or more computer readable storage media; and a file sharing tool comprising program instructions stored on the one or more computer readable storage media that, when read and executed by the processing system, direct the processing system to at least: render a first metadata driven view in a user interface to the file sharing tool, wherein the first metadata driven view includes a first set of pinnable items that match a first set of metadata values; in response to receiving a selection of a pin associated with a pinnable item of the first set of pinnable items, display the pinnable item associated with the selected pin as a tile in a top position within the first metadata driven view; render a second metadata drive view in the user interface to the file sharing tool, wherein the second metadata driven view includes a second set of pinnable items that match a second set of metadata values; and in response to receiving a selection of a pin associated with a pinnable item of the second set of pinnable items, display the pinnable item associated with the selected pin as a tile in a top position within the second metadata driven view. In further examples, the pinnable item displayed as a tile in a top position within the first metadata driven view is distinguished from the first set of pinnable items by size, position and aspect ratio. In further examples, the pinnable item displayed as a tile in a top position within the second metadata driven view is distinguished from the second set of pinnable items by size, position and aspect ratio. In further examples, the pinnable item displayed as a tile in a top position within the first metadata driven view is different from the pinnable item displayed as a tile in a top position within the second metadata driven view.

Techniques for pinning items that span across multiple containers in a collaboration environment are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of file sharing tools that execute in conjunction with a container program that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A computer-implemented method for providing a set of pinned items based on a container, the method comprising:
rendering a first container comprising a folder having a first metadata driven view in a user interface of a file sharing tool, wherein the first container includes a first set of pinnable items;
in response to receiving a selection of a first pin associated with a first pinnable item of the first set of pinnable items, pinning the first pinnable item as a tile in a top position within the first metadata driven view; and
in response to receiving a selection of a second pin associated with a second pinnable item of the first set of pinnable items, pinning the second pinnable item adjacent to the first pinnable item as a tile in the top position within the first metadata driven view.

2. The computer-implemented method of claim 1, further comprising rendering a second container comprising the folder having a second metadata driven view in the user interface of the file sharing tool, wherein the second container includes a second set of pinnable items.

3. The computer-implemented method of claim 1, wherein the first set of pinnable items includes at least one of files, web pages, links to external resources, rich media, and tasks.

4. The computer-implemented method of claim 1, wherein the first container includes a shared library of content.

5. The computer-implemented method of claim 1, wherein the first set of pinnable items match a set of metadata values associated with the first metadata driven view

6. The computer-implemented method of claim 2, wherein the second set of pinnable items match a set of metadata values associated with the second metadata driven view.

7. The computer-implemented method of claim 1, wherein the first container includes an action pane including at least an edit option associated with the first pinnable item pinned as a tile and the second pinnable item pinned as a tile.

8. The computer-implemented method of claim 7, further comprising in response to receiving a selection of the edit option, displaying an edit pane including at least a relocation option and an unpin option.

9. The computer-implemented method of claim 8, further comprising in response to receiving a selection of the relocation option, relocating at least one of the first pinnable item pinned as a tile and the second pinnable item pinned as a tile within the top position of the first metadata driven view.

10. The computer-implemented method of claim 8, further comprising in response to receiving a selection of the unpin option, removing at least one of the first pinnable item pinned as a tile and the second pinnable item pinned as a tile from the top position of the first metadata driven view.

11. A system comprising:
one or more computer readable storage media; and
program instructions stored on the one or more computer readable storage media that, when executed by at least one processor, cause the at least one processor to at least:
initiate rendering of a shared library of content within a file sharing tool, wherein the shared library of content includes at least one or more folders;
in response to receiving a selection of a first of the one or more folders, initiate rendering of a first set of pinnable items within the first selected folder; and
in response to receiving a selection of a second of the one or more folders, initiate rendering of a second set of pinnable items within the second selected folder, wherein the first set of pinnable items includes at least one pinnable item that is different from the second set of pinnable items.

12. The system of claim 11, wherein each folder of the one or more folders includes a unique set of pinnable items.

13. The system of claim 11, wherein in response to receiving a selection of a pin associated with a first pinnable item of the first set of pinnable items, pinning the first pinnable item as a tile in a top position within the first selected folder.

14. The system of claim 11, wherein in response to receiving a selection of a pin associated with a first pinnable item of the second set of pinnable items, pinning the first pinnable item as a tile in a top position within the second selected folder.

15. The system of claim 13, wherein in response to receiving a selection of a pin associated with a second pinnable item of the first set of pinnable items, pinning the second pinnable item adjacent to the first pinnable item as a tile in a top position within the first selected folder.

16. The system of claim 14, wherein in response to receiving a selection of a pin associated with a second pinnable item of the second set of pinnable items, pinning the second pinnable item adjacent to the first pinnable item as a tile in a top position within the second selected folder.

17. A computing apparatus comprising:
one or more computer readable storage media;
a processing system operatively coupled with the one or more computer readable storage media; and
a file sharing tool comprising program instructions stored on the one or more computer readable storage media that, when read and executed by the processing system, direct the processing system to at least:
render a first metadata driven view in a user interface to the file sharing tool, wherein the first metadata driven view includes a first set of pinnable items that match a first set of metadata values;
in response to receiving a selection of a pin associated with a pinnable item of the first set of pinnable items, display the pinnable item associated with the selected pin as a tile in a top position within the first metadata driven view;
render a second metadata drive view in the user interface to the file sharing tool, wherein the second metadata driven view includes a second set of pinnable items that match a second set of metadata values; and
in response to receiving a selection of a pin associated with a pinnable item of the second set of pinnable items, display the pinnable item associated with the selected pin as a tile in a top position within the second metadata driven view.

18. The system of claim 18, wherein the pinnable item displayed as a tile in a top position within the first metadata driven view is distinguished from the first set of pinnable items by size, position and aspect ratio.

19. The system of claim 18, wherein the pinnable item displayed as a tile in a top position within the second metadata driven view is distinguished from the second set of pinnable items by size, position and aspect ratio.

20. The system of claim 18, wherein the pinnable item displayed as a tile in a top position within the first metadata driven view is different from the pinnable item displayed as a tile in a top position within the second metadata driven view.
